(19) United States
(12) Patent Application Publication
(10) Pub. No.: US 2013/0014670 A1
(43) Pub. Date: Jan. 17, 2013

(54) USE OF ANTICORROSION AGENTS FOR CONDITIONING MAGNESIUM METAL, CONDITIONING MATERIAL THUS OBTAINED AND PREPARATION PROCESS

(71) Applicants: David Lambertin, Orange (FR); Fabien Frizon, Villeneuve Lez Avignon (FR); Adrien Blachere, Entraigues Sur Sorgues (FR); Florence Bart, Orsan (FR)

(72) Inventors: David Lambertin, Orange (FR); Fabien Frizon, Villeneuve Lez Avignon (FR); Adrien Blachere, Entraigues Sur Sorgues (FR); Florence Bart, Orsan (FR)

(73) Assignee: COMMISSARIAT A I'ENERGIE ATOMIQUE ET AUX ENERGIES ALTEMATIVES, Paris (FR)

(21) Appl. No.: 13/638,479

(22) PCT Filed: Mar. 29, 2010
(86) PCT No.: PCT/EP2011/054808

§ 371 Date: Oct. 2, 2012

(30) Foreign Application Priority Data
Apr. 1, 2010 (FR) 10 52466

(51) Int. Cl. C04B 9/02

(52) U.S. Cl. 106/14.05

(57) ABSTRACT

Use of at least one corrosion-inhibiting additive to reduce the production of hydrogen via corrosion of magnesium metal conditioned in a cement matrix is provided. Also provided is a material for conditioning magnesium metal given such use and its method of preparation.

### TECHNICAL FIELD

The present invention pertains to the technical field of waste elimination and conditioning (packaging) such as nuclear metal waste containing magnesium metal in particular.

The present invention proposes a method for reducing the hydrogen source term during the immobilization of magnesium metal via a cement matrix. More particularly, the present invention proposes the use of anticorrosion agents to reduce the production of hydrogen when conditioning (packaging) magnesium metal in a hydraulic or geopolymeric cement matrix.

The present invention also concerns the conditioning materials used in this method and a method for preparing such materials.

### STATE OF THE PRIOR ART

Nuclear installations of NUGG type (Natural Uranium Graphite Gas) are based on natural uranium reactors moderated with graphite and cooled. In these installations, the fissile material used is natural uranium in metallic form, whereas the cladding material is in magnesium metal particularly in the form of an alloy.

The operating of this type of installation was halted in France and their dismantling is in progress. In England on the contrary these installations have undergone major development under the name MAGNOX (MAGnesium Non OXidising) with reference to the magnesium alloy used therein which is a magnesium/aluminium alloy.

Both the dismantling and the operating of such installations produce reactive metal waste containing metallic magnesium (or magnesium metal). Several processes to allow the conditioning of this waste have been envisaged.

However, they come up against a problem of the release (or production) of hydrogen resulting from the corrosion of the magnesium metal in the presence of water. Said release may be harmful for the stability of the conditioning and leads to accident risks during the immobilization, warehousing, storage, evacuation and/or transport of such conditioning.

Therefore, the use of a hydraulic binder of Portland cement type to coat reactive metal waste containing magnesium metal is difficult since the release of hydrogen is caused by the reaction between the water of the cement and the magnesium metal [1].

However, since 1990 metal waste derived from MAGNOX reactors containing magnesium metal inter alia have been conditioned with a mix of Portland cement and blast furnace ash or fly ash [1, 2, 3]. The strategy of this formulation is to use a minimum amount of water for the cement hydratation and to reach a high pH (of the order of 12.5) [1]. Concerning the small amount of water to be used, Fairhall and Palmer recommend using a hydraulic cement matrix having a Water/Cement weight ratio, hereinafter called W/C ratio, of less than 0.37 [2]. Similarly, the cement matrixes described in [4] have a W/C ratio of 0.33. However, releases of hydrogen have been observed with the formation of magnesium hydroxide on the surface of the magnesium metal causing damage to the conditioning [4].

One alternative solution to the use of Portland cement has been proposed with the use of a mineral geopolymer [1, 5].

Coating tests on waste of MAGNOX type containing magnesium were conducted with organic polymers [1, 6] to limit the amount of water and thereby prevent the release of hydrogen. Tests were conducted with thermosetting polymers such as epoxy or polyester resins. However, these organic polymers have several disadvantages such as rapid setting and are hence disadvantageous for industrial use and are of high cost [1]. The work described in [6] tested the efficacy of encapsulating MAGNOX type waste with polyurethane under fire conditions.

The inventors have therefore set themselves the objective of proposing a method for conditioning waste containing magnesium metal, wherein the hydrogen produced through corrosion of the magnesium metal is strongly decreased and even inhibited.

Magnesium metal and its alloys are the subject of extensive research for applications in aeronautics, and numerous anticorrosion chemical treatments are available in the literature [7]. Most of these treatments consist in applying a coating to the parts in magnesium metal or an alloy thereof, the coating containing agents such as dichromates, silicates, phosphates and fluorides. In addition, concerning the use of fluoride ions provided in the form of potassium fluoride (KF), sodium fluoride (NaF) or ammonium fluoride (NH₄F) as anticorrosion treatment for magnesium metal, an electrochemical study was able to determine, in solution, the pH and fluoride ion concentration zones in which magnesium metal exhibited the lowest corrosion currents [8]. The pH and fluoride concentration must be higher than 13 and 2 M respectively.

Song and StJohn studied the anticorrosion effect of solutions containing ethylene glycol on pure magnesium, in particular for applications in the automotive sector [9]. The results of this work showed firstly that the rate of corrosion of magnesium decreases with increasing concentrations of ethylene glycol, and secondly the corrosion of magnesium in ethylene glycol can be efficiently inhibited through the addition of fluorides. Similarly the use of fluorides as inhibitors of magnesium corrosion in organic acids such as a combination of alkylbenzoic acid and monobasic or dibasic aliphatic acid has been proposed for the automobile industry [10].

Recently, a method for protecting magnesium metal in a basic environment using a mixture of fluorosilicate, polyphosphate and organic acid was proposed in a Chinese patent application [11].

However, even if the use of corrosion inhibitors in concretes for civil engineering is widely used, persons skilled in the art would have been dissuaded from making use thereof to condition waste containing magnesium metal in order to solve the problem of hydrogen production. Fairhall and Palmer clearly indicate that during tests conducted in the early 80s the use of chromates and fluorides in cement matrixes had no effect on corrosion levels of magnesium metal and consequently on the production of hydrogen [2]. It is also to be pointed out that no technical, practical detail concerning such use is given in document [2].

### DISCLOSURE OF THE INVENTION

The present invention allows the solving of the disadvantages of prior art methods for conditioning waste containing magnesium metal, and allows the objective set by the inventors to be reached namely to propose a method whereby the production of hydrogen due to the oxidative corrosion of magnesium metal is reduced, even inhibited.

Indeed, the inventors have solved this technical problem by adding anticorrosion products directly to the dry hydraulic or geopolymeric cement mix, to the mixing water, to the activation solution or to the slurry when coating magnesium waste with cement matrices. With this work it has therefore been possible to overcome preconceived opinion in the prior art according to which chromates and fluorides do not have any effect on the corrosion of magnesium metal and hence on the production of hydrogen.

The adding of anticorrosion products directly to the dry geopolymeric or hydraulic cement mix, to the mixing water, to the activation solution or to the slurry obtained makes it possible to avoid a pre-treatment step of magnesium metal and hence of the waste in which it is contained before conditioning. In addition, the presence of anticorrosion products in excess in the final coating allows guaranteed efficacy over time.

The material of cement matrix type in which the magnesium metal or a technological waste containing magnesium metal is subsequently incorporated, is therefore easy to prepare, easy to handle and ready for use.

More particularly, the present invention concerns the use of at least one corrosion-inhibiting additive to reduce the production of hydrogen via corrosion of magnesium metal conditioned in a cement matrix.

In other words, the present invention proposes a method for reducing hydrogen production through corrosion of magnesium metal conditioned in a cement matrix, said method consisting in conditioning the magnesium metal in a cement matrix containing at least one corrosion-inhibiting additive.

By [symbol] to reduce hydrogen production [symbol] in the present invention is meant to reduce, minimize or even inhibit hydrogen production compared with the production of hydrogen via corrosion of the same magnesium metal conditioned in the same cement matrix but without any corrosion-inhibiting additive.

By [symbol] magnesium metal [symbol] in the present invention is meant pure magnesium metal or in the form of an alloy of magnesium metal. An alloy of magnesium metal is more particularly chosen from the group consisting of magnesium/aluminium, magnesium/zirconium and magnesium/manganese. In these alloys, the amount of magnesium is higher than 80%, than 90% and than 95% expressed in weight relative to the total weight of the alloy. Magnesium/zirconium and magnesium/manganese alloys derived from NUGG sources are more particularly used in the present invention, the magnesium/aluminium alloy being derived from the MAGNOX source.

The expressions [symbol] magnesium metal [symbol] and [symbol] metallic magnesium [symbol] are equivalent and may be used interchangeably.

The magnesium metal is advantageously contained in technological waste from a dismantling worksite of an installation of NUGG type, or from a dismantling, operating, repair, maintenance worksite of an installation of MAGNOX type.

By [symbol] corrosion-inhibiting additive [symbol] in the present invention is meant an additive capable of inhibiting the corrosion of magnesium metal. Any additive allowing the inhibition of corrosion of magnesium metal known to persons skilled in the art can be used in the present invention and in particular the additives that can be either organic or inorganic cited in document [7]. Advantageously, the corrosion-inhibiting additive used in the present invention is a mineral additive (i.e. inorganic). There is effectively a risk of radiolysis with organic corrosion-inhibiting additives such as carboxylates, since waste containing magnesium metal is radioactive.

More particularly, the corrosion-inhibiting additive is chosen from the group consisting of a fluorinated compound, stannate compound, molybdate compound, silicate compound, cerium(III) compound, phosphate compound, (di)chromated compound and cobalt compound, a carboxylate compound and mixtures thereof.

The fluorinated compound used in the present invention is a source of fluoride ions. Advantageously, this compound is a mineral fluorinated compound notably chosen from the group consisting of sodium fluoride, potassium fluoride, ammonium fluoride, cerium(III) fluoride, lithium fluoride, iron bifluoride, lead bifluoride, potassium bifluoride, sodium bifluoride, titanium fluoride, rubidium fluoride and mixtures thereof.

The stannate compound used in the present invention is a source of stannate SnO₃²⁻ ions or Sn(OH)₆²⁻ ions. Advantageously this stannate compound is chosen from the group consisting of potassium stannate, sodium stannate, barium stannate, zinc stannate, copper stannate and mixtures thereof.

The molybdate compound used in the present invention is a source of oxoanions with molybdenum notably of MoO₄²⁻ or Mo₄O₁₃²⁻ type. Advantageously the molybdate compound is chosen from the group consisting of potassium molybdate, sodium molybdate, zinc molybdate, calcium molybdate, zinc and calcium molybdate and mixtures thereof.

The silicate compound used in the present invention is a source of SiO₄⁴⁻ ions. Advantageously, the silicate compound is chosen from the group consisting of calcium silicate, potassium silicate, sodium silicate, aluminium silicate, calcium borosilicate and mixtures thereof.

The cerium(III) compound used in the present invention is a source of Ce³⁺ cations. Advantageously, the cerium(III) compound is chosen from the group consisting of cerium(III) nitrate, cerium(III) fluoride, cerium(III) chloride, cerium(III) sulfate and mixtures thereof.

The phosphate compound used in the present invention is a source of PO₄³⁻ anions such as zinc phosphate, manganese phosphate or a mixture thereof.

The (di)chromate compound used in the present invention is a source of CrO₄²⁻ or Cr₂O₇²⁻ anions.

Advantageously, the (di)chromate compound is chosen from the group consisting of sodium (di)chromate, potassium (di)chromate, barium (di)chromate, aluminium (di)chromate, zinc (di)chromate and mixtures thereof. The cobalt compound used in the present invention is a source of Co²⁺ cations. Advantageously, the cobalt compound is chosen from the group consisting of cobalt phosphate, cobalt sulfate, cobalt hydroxide, cobalt nitrate and mixtures thereof.

The carboxylate compound used in the present invention is a source of COO⁻ anions such as magnesium carboxylate, sodium carboxylate or a mixture thereof.

By the term [symbol] mixture [symbol] in the present invention is meant firstly a mixture of at least two separate elements belonging to same or different groups of corrosion-inhibiting additives, and secondly a corrosion-inhibiting additive belonging to two different groups of corrosion-inhibiting additives. For example, cerium(III) fluoride is a source both of fluoride ions and of cerium(III) cations, and on this account belongs both to the group of fluorinated compounds and to the group of cerium(III) compounds.

By [symbol] cement matrix [symbol] in the present invention is meant a porous, solid material in the dry state, obtained after setting of a plastic mixture containing finely ground materials and water or a saline solution, said plastic mixture being capable of setting and hardening over time. This mixture can also be designated under the terms [symbol] cement mix [symbol] or [symbol] cement composition [symbol] . Any cement matrix whether natural or synthetic, known to those skilled in the art, can be used in the present invention. The cement matrix in the present invention can be hydraulic or geopolymeric.

Therefore in a first embodiment of the invention, the cement matrix used in the present invention is a hydraulic cement matrix in which setting is the result of hydration of the finely ground materials of the cement mix. The finely ground materials of the cement mix are formed in full or in part of finely crushed clinker. By [symbol] clinker [symbol] is meant a mixture comprising one or more elements chosen from the group consisting of:
a limestone,
a limestone having a CaO content varying between 50 and 60%,
a source of alumina such as ordinary bauxite or red bauxite,
a clay, and
a source of sulfate such as gypsum, semi-hydrated calcium sulfate, plaster, natural anhydrite or lime sulphur ash,
said element(s) being crushed, homogenized and brought to a temperature higher than 1200° C., in particular higher than 1300° C., more particularly of the order of 1450° C. By [symbol] of the order of 1450° C. [symbol] is meant a temperature of 1450° C.±100° C., advantageously a temperature of 1450° C.±50° C. The calcining step at high temperature is called [symbol] clinkerisation [symbol] . After the preparation of the clinker, and before or during the grinding thereof at least one other additive e.g. a sulfate source such as previously defined can be added thereto.

In this first embodiment, the cement matrix can be Portland cement or composite Portland cement. A Portland cement advantageously comprises between 50 and 70% tricalcium silicate [(CaO)₃SiO₂], between 10 and 25% dicalcium silicate [(CaO)₂SiO₂], between 5 and 15% tricalcium aluminate [(CaO)₃Al₂O₃], between 5 and 10% tetracalcium aluminoferrite [(CaO)₄Al₂O₃Fe₂O₃]. Such a Portland cement can be mixed with secondary compounds to yield a [symbol] composite Portland cement [symbol] in which the quantity of secondary compounds such as limestone or blast furnace slag is higher than 3%, in particular between 5 and 80%, more particularly between 10 and 60% by weight relative to the total weight of said composite Portland cement.

In this first embodiment of the invention, the cement matrix can also be an aluminous cement matrix i.e. the clinker of which mostly contains calcium aluminates.

In addition, in this first embodiment of the invention, the cement matrix may also be a sulfo-aluminous and/or ferro-aluminous cement matrix. Patent application EP 0 900 771 particularly describes cement mixes containing sulfo-aluminous and ferro-aluminous clinkers [12]. These clinkers are cement binders having quick-setting properties and obtained by clinkerisation at a temperature varying between 1200 and 1350° C. of mixtures containing at least one lime source such as limestone having a CaO content varying between 50 and 60%, at least one alumina source and at least one sulfate source such as previously defined.

Advantageously, a sulfo-aluminous clinker comprises between 28 and 40% Al₂O₃, between 3 and 10% SiO₂, between 36 and 43% CaO, between 1 and 3% Fe₂O₃, and between 8 and 15% SO₃. A ferro-aluminous clinker comprises between 25 and 30% Al₂O₃, between 6 and 12% SiO₂, between 36 and 43% CaO, between 5 and 12% Fe₂O₃, and between 5 and 10% SO₃.

In hydraulic cement matrixes, the hydration of the finely ground materials of the cement mix requires the use of a so-called << mixing solution >>. In the present invention, this mixing solution may comprise at least one corrosion-inhibiting additive such as previously defined. The solvent of the mixing solution is a protic solvent and in particular it is water. The concentration of corrosion-inhibiting additive(s) in the mixing solution is advantageously between 10 mM and 10 M, in particular between 100 mM and 8 M and more particularly between 200 mM and 5 M.

As already explained, the hydraulic cement matrixes used for conditioning magnesium metal in the state of the art must contain a small amount of water to prevent corrosion of the magnesium metal and hence the production of hydrogen. In the present invention, adding corrosion inhibitor(s) to the mixing water makes it possible to solve the technical problem of hydrogen production: the hydraulic cement matrixes are therefore not limited as to the amount of water to be used.

Therefore, the W/C ratio in the present invention is advantageously higher than 0.2 and in particular it is between 0.3 and 1.5, and more particularly between 0.38 and 1. By [symbol] W/C ratio [symbol] is meant the weight ratio of the quantity of water (i.e. the quantity of mixing solution) to the quantity of cement (i.e. the dry cement mix which corresponds to the cement mix without the mixing solution).

In a second embodiment of the invention, the cement matrix used in the present invention is a geopolymeric cement matrix in which setting is the result of the dissolution/polycondensation of the finely ground materials of the cement mix in a saline solution such as a saline solution with strong pH.

In this second embodiment, the geopolymeric cement matrix is therefore a geopolymer. By [symbol] geopolymer [symbol] in the present invention is meant an inorganic amorphous alumino-silicate polymer. Said polymer is obtained from a reactive material essentially containing silica and aluminium, activated by a strong alkaline solution, the weight ratio of solid/solution in the formulation being low. The structure of a geopolymer is composed of a Si—O—Al lattice formed of tetrahedrons of silicates (SiO₄) and aluminates (AlO₄) bonded at their apexes by shared oxygen atoms. Within this lattice, there are one or more charge-compensating cations, also called compensating cations, which compensate for the negative charge of the AlO₄⁻ complex. Said compensating cation(s) are advantageously chosen from the group consisting of the alkaline metals such as lithium (Li), sodium (Na), potassium (K), rubidium (Rb) and caesium (Cs), the alkaline-earth metals such as magnesium (Mg), calcium (Ca), strontium (Sr) and barium (Ba) and mixtures thereof. The reactive material essentially containing silica and aluminium which can be used to prepare the geopolymeric cement matrix used in the present invention is advantageously a solid source containing amorphous aluminosilicates. These amorphous alumino-silicates are notably chosen from among the natural aluminosilicate minerals such as illite, stilbite, kaolinite, pyrophyllite, andalusite, bentonite, kyanite, milanite, grovenite, amesite, cordierite, feldspar, allophane, etc. . . . ; natural, calcined aluminosilicate minerals such as metakaolin; synthetic glass containing pure aluminosilicates; aluminous cement; pumice; calcining by-products or industrial residues such as blast furnace fly ash and slag respectively obtained from the burning of coal and during the conversion of iron ore to cast iron in a blast furnace; and mixtures thereof.

The saline solution of strong pH, also known in the geopolymerisation domain as an [symbol] activation solution [symbol] is a highly alkaline aqueous solution which may optionally contain silicate components chosen in particular from the group consisting of silica, colloidal silica and vitreous silica. By [symbol] highly alkaline [symbol] or [symbol] of strong pH [symbol] is meant a solution the pH of which is higher than 9, in particular higher than 10, more particularly higher than 11 and further particularly higher than 12.

The saline solution of strong pH comprises the compensating cation or mixture of compensating cations in the form of an ionic solution or a salt. Therefore the saline solution of strong pH is particularly chosen from among an aqueous solution of sodium silicate (Na₂SiO₃), of potassium silicate (K₂SiO₂), of sodium hydroxide (NaOH), of potassium hydroxide (KOH), of calcium hydroxide (Ca(OH)₂), of caesium hydroxide (CsOH) and the derivatives thereof etc. . . . .

In the present invention, the activation solution may further comprise at least one corrosion-inhibiting additive such as previously defined. The concentration of corrosion-inhibiting additive(s) in the activation solution is advantageously between 10 mM and 10 M, in particular between 100 mM and 8 M and more particularly between 200 mM and 5 M.

The present invention also concerns a material for conditioning magnesium metal comprising a cement matrix with a corrosion-inhibiting additive according to the present invention (i.e. according to the two embodiments envisaged for the cement matrix).

Therefore, in a first embodiment, the magnesium metal conditioning material comprises a hydraulic cement matrix in which the magnesium metal is conditioned, the hydraulic cement matrix further comprising at least one corrosion-inhibiting additive chosen from the group consisting of a fluorinated compound, stannate compound, molybdate compound, silicate compound, cerium(III) compound, phosphate compound, (di)chromate compound, cobalt compound, carboxylate compound and mixtures thereof.

In a second embodiment, the present invention also concerns a magnesium metal conditioning material comprising a geopolymeric cement matrix, in which the magnesium metal is conditioned, the geopolymeric cement matrix further comprising at least one corrosion-inhibiting additive chosen from the group consisting of a fluorinated compound, stannate compound, molybdate compound, cerium(III) compound, phosphate compound, (di)chromate compound, cobalt compound, carboxylate compound and mixtures thereof.

In the material subject of the present invention having a cement matrix that is either hydraulic or geopolymeric, the corrosion-inhibiting additive is incorporated in the cement matrix up to a rate of incorporation of 20% by weight relative to the total weight of said material. Advantageously, this level of incorporation is between 0.01 and 15%, in particular between 0.1 and 10% by weight relative to the total weight of the said material.

The material subject of the present invention having a hydraulic or geopolymeric matrix can be in various forms, of small or large size, in relation to the desired application and the quantity of magnesium metal to be conditioned. In the present invention, the magnesium metal and in particular the waste in which it is contained is encapsulated, coated and/or dispersed in the cement matrix.

The present invention also concerns a method for preparing a material for conditioning magnesium metal such as previously defined. Said preparation method comprises the following successive steps of:
incorporating at least one corrosion-inhibiting additive in a hydraulic or geopolymeric cement mix, then
conditioning the magnesium metal or waste containing magnesium metal in the hydraulic or geopolymeric cement mix thus obtained (i.e. the hydraulic or geopolymeric cement mix+corrosion-inhibiting additive(s)).

Regarding the incorporation of the corrosion-inhibiting additive, three variants can be envisaged.

In a first variant, at least one corrosion-inhibiting additive is added to the dry hydraulic or geopolymeric cement mix, before adding the mixing solution or activation solution respectively.

The cement mix used in the method for preparing the conditioning material according to the first variant applied to the first embodiment (hydraulic cement mix) comprises:

i₁) a mixing solution in particular such as previously defined,

ii₁) a clinker in particular such as previously defined, comprising at least one corrosion-inhibiting additive, in particular such as previously defined, and

iii₁) optionally a sulfate source in particular such as previously defined.

The cement mix used in the method for preparing the conditioning material according to the first variant applied to the second embodiment (geopolymeric cement mix) comprises:

i₁′) an activation solution i.e. a saline solution with strong pH, in particular such as previously defined,

ii₁′) a solid source containing amorphous aluminosilicates in particular such as previously defined, containing at least one corrosion-inhibiting additive in particular such as previously defined, and

iii₁′) optionally silicate components such as previously defined.

In a second variant, at least one corrosion-inhibiting additive is added to the mixing solution (for hydraulic cement matrices) or to the activation solution (for geopolymeric cement matrixes).

The cement mix used in the method for preparing the conditioning material according to the second variant applied to the first embodiment (hydraulic cement mix) comprises:

i₂) a mixing solution in particular such as previously defined, comprising at least one corrosion-inhibiting additive in particular such as previously defined,

ii₂) a clinker, in particular such as previously defined, and

iii₂) optionally a sulfate source, in particular such as previously defined.

The cement mix used in the method for preparing the conditioning material according to the second variant applied to the second embodiment (geopolymeric cement mix) comprises:

i₂′) an activation solution i.e. a saline solution with strong pH in particular such as previously defined, comprising at least one corrosion-inhibiting additive in particular such as previously defined,

ii₂′) a solid source containing amorphous aluminosilicates in particular such as previously defined, and

iii₂′) optionally silicate components in particular such as previously defined.

The constituent elements of the cement mix can be mixed together either per group, or simultaneously. The protocols followed are conventional protocols for preparing hydraulic or geopolymeric cements.

In a third variant, at least one corrosion-inhibiting additive is added to the cement mix after adding the mixing solution (for hydraulic cement matrices) or the activation solution (for geopolymeric cement matrices). In this variant, the corrosion-inhibiting additive is added to the slurry.

The cement mix used in the method for preparing the conditioning material according to the third variant applied to the first embodiment (hydraulic cement mix) comprises:

i₃) a mixing solution in particular such as previously defined,

ii₃) a clinker in particular such as previously defined,

iii₃) at least one corrosion-inhibiting additive in particular such as previously defined, and

iv₃) optionally a sulfate source in particular such as previously defined.

The cement mix used in the method for preparing the conditioning material according to the third variant applied to the second embodiment (geopolymeric cement mix) comprises:

i₃′) an activation solution i.e. a saline solution with strong pH in particular such as previously defined,

ii₃′) a solid source containing amorphous aluminosilicates in particular such as previously defined,

iii₃′) at least one corrosion-inhibiting additive in particular such as previously defined, and

iv₃′) optionally silicate components in particular such as previously defined.

The corrosion-inhibiting additives able to be used in the present invention are commercially available compounds which do not require any particular preparation before being added to the hydraulic or geopolymeric cement mix. However, if necessary those skilled in the art will easily be able to prepare one (or more) corrosion-inhibiting additives using known techniques.

Before being incorporated in the dry cement mix, in the mixing solution, in the activation solution or in the slurry, the corrosion-inhibiting additive is advantageously in solid form such as a powder, or in liquid form. Therefore adding this additive to the dry cement mix, to the mixing solution, to the activation solution or to the slurry is a simple protocol consisting in mixing, dissolving or diluting.

If several corrosion-inhibiting additives are used, they can be added according to the same variant chosen from among the three above variants, or according to different variants chosen from among the three above variants.

Subsequent to the incorporation step of at least one corrosion-inhibiting additive in the hydraulic or geopolymeric mix using the method of the invention, the cement mix in which the corrosion-inhibiting additive is incorporated is used to condition magnesium metal and in particular waste containing magnesium metal. This step consists more particularly in adding (or dispersing) the magnesium metal or waste in the cement mix or in covering (coating, encapsulating, trapping or blocking) the magnesium metal or waste with the cement mix.

In one particular embodiment the magnesium metal or waste, notably technological waste, in which it is contained is placed in a container of drum type, then the cement mix in which the corrosion-inhibiting additive is incorporated is poured into the container so as to fill the entire free space between the magnesium metal or waste.

Further to the conditioning step of the magnesium metal or waste containing the same in a cement mix containing at least one corrosion-inhibiting additive according to the method of the invention, the cement mix in which the corrosion-inhibiting additive and the magnesium metal (or waste in which it is contained) are incorporated is advantageously subjected to conditions allowing the setting of the cement matrix. Therefore, after the magnesium metal or waste containing the same has been conditioned in the hydraulic or geopolymeric cement mix, the cement mix is subjected to conditions under which the cement matrix is able to set. Any technique known to persons skilled in the art to obtain the setting of a hydraulic cement mix or a geopolymeric cement mix can be used during the setting step of the method.

This setting advantageously comprises a curing step and/or a drying step. If the setting step includes curing, this can be carried out by humidifying the atmosphere surrounding the cement mix in which the corrosion-inhibiting additive and the magnesium metal (or waste containing the same) are incorporated, or by applying an impervious coating to said mix. This curing step can be performed at a temperature of between 10 and 60° C., in particular between 20 and 50° C. and more particularly between 30 and 40° C. and can last between 1 and 40 days, in particular between 5 and 30 days and more particularly between 10 and 20 days.

If the setting step comprises a drying step, this can be carried out at a temperature of between 30 and 90° C., in particular between 40 and 80° C. and more particularly between 50 and 70° C. and can last between 6 h and 10 days, in particular between 12 h and 5 days and more particularly between 24 and 60 h. Advantageously the setting step comprises a curing step followed by a drying step such as previously defined.

Additionally, prior to the setting of the cement mix in which the corrosion-inhibiting additive and the magnesium metal (or waste containing the same) are incorporated, it can be placed in moulds to impart a predetermined shape thereto after setting.

Other characteristics and advantages of the present invention will become further apparent on reading the examples below given as non-limiting illustrations, with reference to the appended Figures.

### BRIEF DESCRIPTION OF THE DRAWINGS

FIG. 1 illustrates the influence of the fluoride present in the mixing water of CEM I cement on the release of hydrogen in the presence of magnesium metal.

FIG. 2 illustrates the influence of the fluoride present in the activation solution of a geopolymer on the release of hydrogen in the presence of magnesium metal.

### DETAILED DESCRIPTION OF PARTICULAR EMBODIMENTS

### 1. Preparation of a Slurry with Sodium Fluoride for Immobilising Magnesium Metal

Slurries containing fluorides were prepared from different binders. The two binders used to prepare the slurries were the following:
Geopolymer (slurries n° 1 and n° 2)
CEM I Portland cement (slurry n° 3)

Aqueous solutions with sodium fluoride (Merck 99%) were prepared at a concentration of 2.58 M (slurries n° 1 and 3) and of 0.258 M (slurry n° 2). These solutions were used in slurries n° 1 and n° 2 as activation solution and as mixing solution for slurry n° 3.

The products used for the geopolymer were metakaolin from Pieri Premix MK (Grade Construction Products), NaOH (Prolabo 98%) and SiO₂ (Tixosil, Degussa).

The Portland-based slurry was prepared with cement of CEM I 52.5 N type (Lafarge Le teil).

The compositions of the different slurries are given in Table 1 below.

TABLE 1
Composition of the different slurries to immobilise the magnesium

| | | | NaF |
|---|---|---|---|
| | Binder | Water/cement, or | weight |
| | composition | Water/Metakaolin | (in g) |
| slurry 1: | Metakaolin: | 0.68 | 6.3 |
| geopolymer | 87.8 g | | |
| | SiO₂: 20.02 g | | |
| | NaOH: 22.21 g | | |
| slurry 2: | Metakaolin: | 0.68 | 0.63 |
| geopolymer | 87.8 g | | |
| | SiO₂: 20.02 g | | |
| | NaOH: 22.21 g | | |
| slurry 3: | CEM I cement: | 0.4 | 3.4 |
| Portland | 80 g | | |
| CEM I | | | |

After mixing the slurries for 1 min, they were placed in contact with the magnesium metal and the release of hydrogen was measured as a function of time.

### 2. Influence of the Fluoride on the Release of Hydrogen from the Slurries in the Presence of Magnesium Metal

To determine the influence of the presence of fluoride on the release of hydrogen from slurries n° 1, 2 and 3 in the presence of magnesium metal, analyses in a hermetic pot were conducted and a comparison between slurries n° 1, 2 and 3 without fluoride was conducted as a function of time.

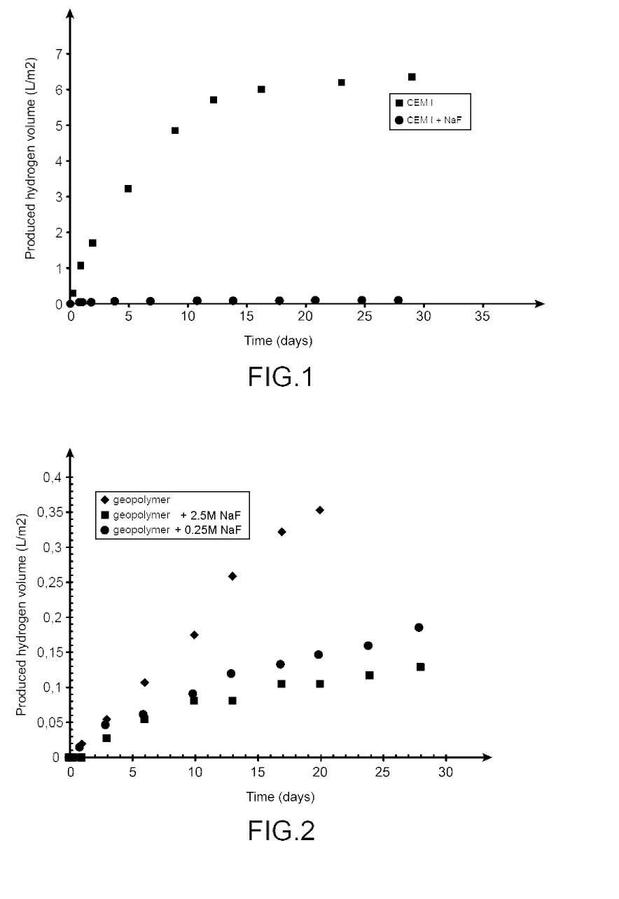

FIG. 1 gives the volume of hydrogen produced by slurries of CEM I+NaF (slurry n° 3) and CEM I without NaF in the presence of magnesium metal. A distinct reduction in the volume of hydrogen produced by magnesium metal is induced with the presence of fluoride in the mixing water.

FIG. 2 gives the results for the geopolymer and shows that the increase in the quantity of fluoride in the activation solution induces a decrease in the quantity of hydrogen produced by magnesium metal.

### 3. Conclusions

The incorporation of magnesium corrosion inhibitors (fluoride, silicates . . . ) in the mixing water of Portland cement or in the activation solution of a geopolymer allows a reduction to be obtained in the quantity of hydrogen produced by magnesium metal contained in a matrix of hydraulic binder or of amorphous aluminosilicate polymers.

### REFERENCES

1. Article by Morris et al., 2009, “Contingency options for the drying, conditioning and packaging of Magnox spent fuel in the UK”, Proceedings of the 12^{th} International Conference on Environmental Remediation and Radioactive Waste Management, ICEM2009, Oct. 11-15, 2009, Liverpool, UK.
2. Article by Fairhall and Palmer, 1992, “The encapsulation of Magnox in cement in the United Kingdom”, Cement and Concrete Research, vol. 22, pages 293-298.
3. Article by Spasova and Ojovan, 2008, “Characterisation of Al corrosion and its impact on the mechanical performance of composite cement wasteforms by the acoustic emission technique”, Journal of Nuclear Materials, vol. 375, pages 347-358.
4. Article by Setiadi et al., 2006, “Corrosion of aluminium and magnesium in BFS composite cements”, Advances in Applied Ceramics, vol. 105, pages 191-196.
5. Article by Zosin et al., 1998, “Geopolymer materials based on magnesia-iron slags for normalization and storage of radioactive wastes”, Atomic Energy, vol. 85, pages 510-514.
6. Article by Turner et al., 2007, “Small scale fire testing of polymer as an encapsulant for Magnox waste”, Proceedings of the 15th International Symposium on the Packaging and Transportation of Radioactive Materials (PATRAM 2007), Miami, Fla.
7. Article by Gray and Luan, 2002, “Protective coatings on magnesium and its alloys—a critical review”, Journal of Alloys and Compounds, vol. 336, pages 88-113.
8. Article by Gulbrandsen et al., 1993, “The passive behaviour of Mg in alkaline fluoride solutions. Electrochemical and electron microscopical investigations”, Corrosion Science, vol. 34, pages 1423-1440.
9. Article by Song and StJohn, 2004, “Corrosion behaviour of magnesium in ethylene glycol”, Corrosion Science, vol. 46, pages 1381-1399.
10. Patent application EP 0 995 785 filed by Texaco Development Corporation and published on 26 Apr. 2000.
11. Chinese patent application N° 101358343 filed by University Jiaotong SouthWest and published on 4 Feb. 2009.
12. European patent application N° 0 900 771 filed by CIMENTS FRANçAIS and published under number EP on 10 Mar. 1999.

1-15. (canceled)

16. A method for reducing production of hydrogen via corrosion of magnesium metal conditioned in a geopolymeric cement matrix, comprising:
conditioning the magnesium metal in a geopolymeric cement matrix containing at least one corrosion-inhibiting additive.

17. The method according to claim 16, wherein said magnesium metal is pure or is in form of an alloy.

18. The method according to claim 16, wherein said corrosion-inhibiting additive is selected from the group consisting of a fluorinated compound, a stannate compound, a molybdate compound, a cerium(III) compound, a phosphate compound, a (di)chromate compound, a cobalt compound, a carboxylate compound and mixtures thereof.

19. A material for conditioning magnesium metal comprising a geopolymeric cement matrix in which the magnesium metal is conditioned, the geopolymeric cement matrix further comprising at least one corrosion-inhibiting additive selected from the group consisting of a fluorinated compound, a stannate compound, a molybdate compound, a cerium(III) compound, a phosphate compound, a (di)chromate compound, a cobalt compound, a carboxylate compound and mixtures thereof.

20. The conditioning material according to claim 19, wherein said corrosion-inhibiting additive(s) are incorporated in the cement matrix up to a rate of incorporation of 20% by weight relative to a total weight of said material.

21. A method for preparing a conditioning material, wherein said method comprises the following successive steps of:
incorporating at least one corrosion-inhibiting additive in a geopolymeric cement matrix, then
conditioning magnesium metal or waste containing magnesium metal in the geopolymeric cement mix thus obtained.

22. The preparation method according to claim 21, wherein said corrosion-inhibiting additive is selected from the group consisting of a fluorinated compound, a stannate compound, a molybdate compound, a cerium(III) compound, a phosphate compound, a (di)chromate compound, a cobalt compound, a carboxylate compound and mixtures thereof.

23. The preparation method according to claim 21, wherein at least one corrosion-inhibiting additive is added to the dry, geopolymeric cement mix prior to adding an activation solution.

24. The preparation method according to claim 21, wherein at least one corrosion-inhibiting additive is added to an activation solution.

25. The preparation method according to claim 21, wherein at least one corrosion-inhibiting additive is added to the cement mix after adding an activation solution.

26. The preparation method according to claim 21, wherein, after conditioning the magnesium metal or waste containing magnesium metal in the geopolymeric cement mix, the cement mix is subjected to conditions allowing setting the cement matrix.

27. The method according to claim 17, wherein said alloy is selected from the group consisting of an alloy of magnesium/aluminium, of magnesium/zirconium, and of magnesium/manganese.

28. The conditioning material according to claim 19, wherein said corrosion-inhibiting additive(s) are incorporated in the cement matrix up to a rate of incorporation ranging between 0.01 and 15% by weight relative to a total weight of said material.

29. The conditioning material according to claim 19, wherein said corrosion-inhibiting additive(s) are incorporated in the cement matrix up to a rate of incorporation ranging between 0.1 and 10% by weight relative to a total weight of said material.
